(19) United States
(12) Patent Application Publication
(10) Pub. No.: US 2022/0356068 A1
(43) Pub. Date: Nov. 10, 2022

(54) LITHIUM VANADIUM OXIDE CRYSTAL, ELECTRODE MATERIAL, AND POWER STORAGE DEVICE, AND METHOD FOR MANUFACTURING LITHIUM VANADIUM OXIDE CRYSTAL

(71) Applicants: NIPPON CHEML-CON CORPORATION, Shinagawa-ku (JP); NATIONAL UNIVERSITY CORPORATION TOKYO UNIVERSITY OF AGRICULTURE AND TECHNOLOGY, Tokyo (JP); K & W LIMITED, Tokyo (JP)

(72) Inventors: Katsuhiko NAOI, Tokyo (JP); Wako NAOl, Tokyo (JP); Etsuro lWAMA, Tokyo (JP); Kenji MACHIDA, lbaraki (JP); Tatsuya KONDO, Ibaraki (JP)

(21) Appl. No.: 17/765,108

(22) PCT Filed: Sep. 4, 2020
(86) PCT No.: PCT/JP2020/033599

§ 371 Date: Mar. 30, 2022

(30) Foreign Application Priority Data
Oct. 18, 2019 (JP) 2019-190755

(51) Int. Cl. C01D 15/02; H01M 10/0525; C01G 31/00; C01G 31/02

(52) U.S. Cl. CPC C01D 15/02; H01M 10/0525; C01G 31/006; C01G 31/02; C01P 2002/77; C01P 2006/40; C01P 2006/80

(57) ABSTRACT

A lithium vanadium oxide crystal and usage thereof that can achieve further excellent electrochemical characteristics are provided. New lithium vanadium oxide crystal is a lithium vanadium oxide crystal which is Li₃VO₄ to which tetravalent metal species M is doped, in which the lithium vanadium oxide crystal is represented by a chemical formula of Li₃₊₁V₁₋ₓMₓO₄ and includes only a single crystal structure with γ-phase as Li₃VO₄ under a temperature environment including normal temperature, and the tetravalent metal species M is included in a ratio of x≥0.2.

### CROSS-REFERENCE TO RELATED APPLICATIONS

This application is a 371 National Stage Entry of PCT application PCT/JP2020/033599, filed Sep. 4, 2020, entitled “LITHIUM VANADIUM OXIDE CRYSTAL, ELECTRODE MATERIAL, AND POWER STORAGE DEVICE, AND METHOD FOR MANUFACTURING LITHIUM VANADIUM OXIDE CRYSTAL”, which is based upon and claims the benefit of priority from Japan Patent Application No. 2019-190755, filed on Oct. 18, 2019, both of which are hereby expressly incorporated by reference in their entireties.

### FIELD OF INVENTION

The present disclosure relates to a lithium vanadium oxide crystal, electrode material including the lithium vanadium oxide crystal, and a power storage device using said electrode material in a positive electrode or a negative electrode.

### BACKGROUND

The charge/discharge potential (vs. Li/Li+) of crystals of lithium vanadium oxide, such as lithium vanadate of the chemical formula of Li₃VO₄ is lower than the charge/discharge potential of lithium titanate (Li₄Ti₅O₁₂) and B-type titanium oxide (TiO₂ (B)). Therefore, when the lithium vanadium oxide crystal is used as a negative electrode of a power storage device, said power storage device would achieve high energy density. Meanwhile, the charge/discharge potential (vs. Li/Li+) of lithium vanadium oxide crystal is higher than the charge/discharge potential of graphite. Therefore, when the lithium vanadium oxide crystal is used as a negative electrode of a power storage device, said power storage device would expect high safety.

Furthermore, it has been reported that the theoretical capacity of a capacitor using the lithium vanadium oxide crystal as the negative electrode was twice as much as the capacity of a capacitor using lithium titanate. Also, as for the cycle characteristic, the capacitor using the lithium vanadium oxide crystal as the negative electrode maintains high-capacity retention rate and high charge/discharge efficiency.

Therefore, the lithium vanadium oxide crystal is expected to be employed in power storage devices, such as lithium-ion secondary batteries using metal compound particles in each positive electrode and negative electrode and hybrid capacitors using activated carbon as a positive electrode and material that can reversibly adsorb/desorb lithium ions as a negative electrode, and the study for the lithium vanadium oxide crystal is continued.

Generally, in the temperature range of −40 to +60° C. including normal temperature, the lithium vanadium oxide crystal has β-phase crystal structure that is more stable. Therefore, when simply employing the lithium vanadium oxide crystal in the power storage device, such a power storage device would be affected by the electrochemical characteristics of the lithium vanadium oxide crystal with β-phase crystal structure. The β-phase crystal structure of the lithium vanadium oxide crystal is a wurtzite-type, and the space group thereof is Pnm2₁.

### PRIOR ART DOCUMENT

### Patent Document

Patent Document 1: Japanese Laid-Open Application 2008-77847

### SUMMARY OF INVENTION

### Problems to be Solved by Invention

FIG. 1 is a graph illustrating lithium-ion diffusion coefficients of a capacitor in which a lithium vanadium oxide crystal with β-phase crystal structure is conjugated with carbon and composite thereof is used for negative electrode material as active material. As illustrated in FIG. 1, the problem is that there is a range where the diffusion coefficient keenly decreases as the charging rate of the capacitor increases. The decrease of the lithium-ion diffusion coefficient inhibits to achieve higher input and output in the power storage device using the lithium vanadium oxide crystal.

Therefore, the objective of the present disclosure is to provide a lithium vanadium oxide crystal and usage thereof that can achieve further excellent electrochemical characteristics in the temperature range including normal temperature.

### Means to Solve the Problem

To achieve the above objective, a lithium vanadium oxide crystal according to the present disclosure is a lithium vanadium oxide crystal which is Li₃VO₄ to which tetravalent metal species M is doped,

in which:

the lithium vanadium oxide crystal is represented by a chemical formula of Li₃₊₁V₁₋ₓMₓO₄ and includes only a single crystal structure with γ-phase as Li₃VO₄ under a temperature environment including normal temperature, and

the tetravalent metal species M is included in a ratio of x≥0.2.

The tetravalent metal species M may be Si.

The tetravalent metal species M may be included in a ratio of 0.2≤x≤0.4.

Electrode material may include said lithium vanadium oxide crystal.

The electrode material may include composite particles formed by conjugating the lithium vanadium oxide crystal and carbon.

A power storage device may employ said electrode material in a negative electrode or a positive electrode.

Furthermore, to achieve the above objective, a production method of a lithium vanadium oxide crystal according to the present disclosure, the lithium vanadium oxide crystal is Li₃VO₄ to which tetravalent metal species M is doped and is represented by a chemical formula of Li₃₊₁V₁₋ₓMₓO₄, and includes:

a mixing process of mixing a lithium source, a vanadium source, and a source of tetravalent metal species M added in a molar ratio of x≥0.2, and

a heating process of heating a mixture obtained in the mixing process under temperature environment equal to or more than temperature at which a phase of the mixture structurally transits to a γ-phase.

The production method may include a pre-heating process of heating the mixture obtained in the mixing process under temperature environment less than the temperature at which the phase of the mixture structurally transits to the γ-phase between the mixing process and the heating process, and the heating process may heat the mixture after the mixing process and after the pre-heating process.

### Effect of Invention

According to the present disclosure, if the lithium vanadium oxide crystal includes a single crystal structure of only γ-phase and includes the tetravalent metal species with coefficient x in the ratio x≥0.2, the lithium-ion diffusion coefficient significantly improves, excellent electrochemical characteristic may be achieved in view of a rate characteristic.

### BRIEF DESCRIPTION OF DRAWINGS

FIG. 1 is a graph illustrating lithium-ion diffusion coefficients of a capacitor in which a composite of a conventional lithium vanadium oxide crystal and carbon is used.

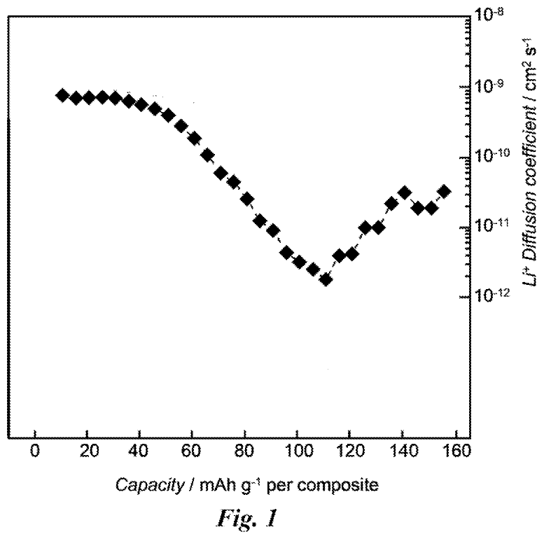

FIG. 2 is a graph on simulation illustrating analysis result of powder X-ray diffraction on lithium vanadium oxide crystals with respective crystal structures.

FIG. 3 is a graph illustrating analysis result of powder X-ray diffraction on composites of each comparative example and each example under normal temperature environment.

FIG. 4 is a graph illustrating lithium diffusion coefficients of composites of each comparative example and each example.

FIG. 5 is a graph illustrating rate characteristics at the time of charging of half cells using composites of each comparative example and each example.

### EMBODIMENT S

In below, embodiments of the present disclosure will be described. Note that the present disclosure is not limited to the following embodiments.

### INDUSTRIAL APPLICABILITY

A lithium vanadium oxide crystal (hereinafter, referred to as the present lithium vanadium oxide crystal) is material can reversibly adsorb and desorb lithium ions, and for example, is preferable for applications as electrode material of power storage devices. The power storage device may be lithium-ion secondary batteries and hybrid capacitors.

In the lithium-ion secondary battery, a positive electrode includes an active material layer including lithium metal compounds, a negative electrode includes an active material layer including the present lithium vanadium oxide crystal, and the positive electrode and the negative electrode becomes Faraday's reaction electrodes which lithium ions would be reversibly inserted to and desorbed from. In the hybrid capacitor, for example, a positive electrode is a polar electrode including activated carbon and utilizes power storage action of an electric double layer formed on an interface between the activated carbon and an electrolyte, and a negative electrode includes an active material layer including the present lithium vanadium oxide crystal and is a Faraday's reaction electrode which lithium ions would be reversibly inserted to and desorbed from.

(Present Lithium Vanadium Oxide Crystal)

The present lithium vanadium oxide crystal is formed by doping tetravalent metal species M to Li₃VO₄ and is solid solution of Li₃VO₄ and Li₄MO₄. The present lithium vanadium oxide crystal only has a single crystal structure of only γ-phase at the temperature range of −40 to +60° C. including normal temperature. A γ-phase single crystal structure in the lithium vanadium oxide crystal is a so-called LISICON (Lithium Super Ionic CONductor) and is a Pnma crystal structure. That is, the basic skeleton of the present lithium vanadium oxide crystal with the γ-phase single crystal structure is a tetrahedral LiO₄ coordination geometry and a tetrahedral VO₄ coordination geometry, and the present lithium vanadium oxide crystal has an octahedral LiO₆ coordination geometry.

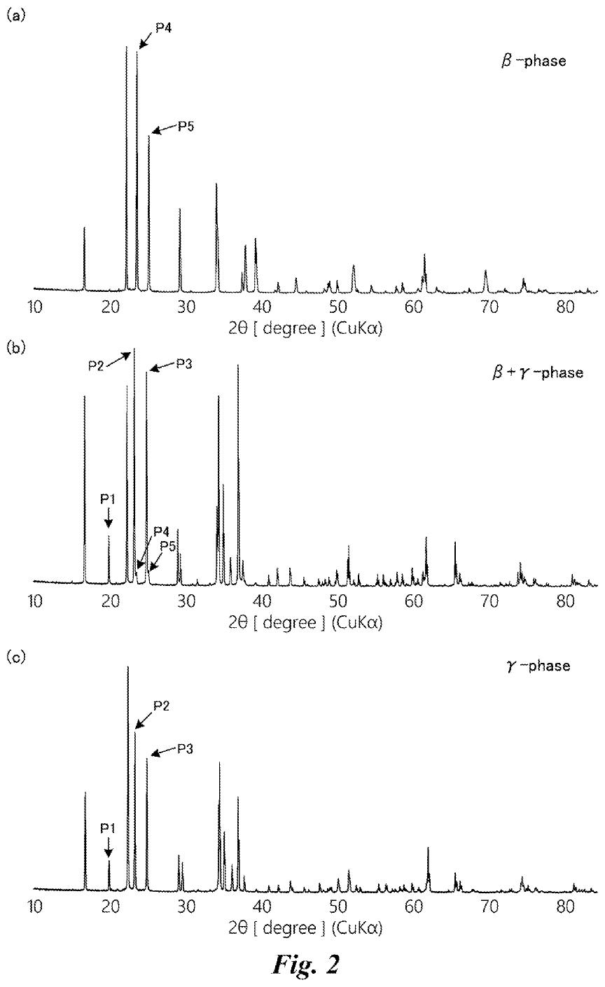

The crystal structure of the present lithium vanadium oxide crystal with the single crystal structure of only γ-phase is specified by the result of X-ray diffraction illustrated in FIG. 2. FIG. 2 is a graph illustrating analysis results of powder X-ray diffraction on the present lithium vanadium oxide crystal, and (a) illustrates the lithium vanadium oxide crystal with the single crystal structure of only β-phase, (b) illustrates the lithium vanadium oxide crystal with the crystal structure of both β-phase and γ-phase, and (c) illustrates the present lithium vanadium oxide crystal with the single crystal structure of only γ-phase.

As illustrated in FIG. 2, in the lithium vanadium oxide crystal with the γ-phase single crystal structure, a peak P1 appears around the incident angle 2θ of 19°, which does not appear in the β-phase crystal structure. This peak P1 shifts in the range of 17° to 21° by the tetravalent metal species M.

Furthermore, in the lithium vanadium oxide crystal with β-phase crystal structure, a peak P4 appears in the range of the incident angle 2θ of 22.7° to 22.9°, and a peak P5 appears in the range of the incident angle 2θ of 24.1° to 24.3°. In the lithium vanadium oxide crystal with the crystal structure with both β-phase and γ-phase, these peaks P4 and P5 becomes small, and large peaks P2 and P3 resulting from γ-phase appear right next at the lower angle side of the peaks P4 and P5, respectively. In the present lithium vanadium oxide crystal with the single crystal structure of only γ-phase, small peaks P4 and P5 resulting from β-phase disappear, and there will only be the peaks P2 and P3.

The tetravalent metal species M may be Si, Ti, or Ge, etc. The present lithium vanadium oxide crystal is expressed by the chemical formula of Li₃₊₁V₁₋ₓMₓO₄. The present lithium vanadium oxide crystal has Li₃VO₄ a mother structure and is formed by partially replacing V⁵⁺ by M⁴⁺ and introducing interstitial Li. In the chemical formula of Li₃₊₁V₁₋ₓMₓO₄, the coefficient x of the metal species M is equal to or more than 0.2 and is preferably equal to or less than 0.4.

When the lithium vanadium oxide crystal has the γ-phase crystal structure and is dissolved so that the coefficient x of the tetravalent metal species M becomes equal to or more than 0.2, the diffusion coefficient of the lithium ion is improved. That is, the range in the logarithmic graph of the diffusion coefficient where the diffusion coefficient keenly drops as the increase in capacity would disappear. Accordingly, the rate characteristic of the storage device using the present lithium vanadium oxide crystal improves.

When the coefficient x of the tetravalent metal species M is less than 0.2, the improvement of the diffusion coefficient of the lithium ion would be limited. That is, in the logarithmic graph of the diffusion coefficient, the keen drop of the diffusion coefficient due to the increase in capacity is mitigated, however, where the diffusion coefficient keenly drops does exist. Furthermore, when the coefficient x of the tetravalent metal species M becomes 0.6, impurities would be included in the lithium vanadium oxide crystal with the single crystal structure of only γ-phase. Therefore, it is preferable that the coefficient x of the tetravalent metal species M is 0.2≤x≤0.4.

Furthermore, the present lithium vanadium oxide crystal is preferably nanoparticles of 10 nm to 300 nm, and is more preferably a granulated body of 10 nm to 100 nm in which fine particle group is granularly solidified and a number of gaps is present therein. By the microminiaturization of the present lithium vanadium oxide crystal, the diffusion coefficient of the lithium ions is improved, and the rated characteristic is further improved.

It is preferable that the present lithium vanadium oxide crystal is conjugated with carbon when using the crystal in the power storage device. By the conjugation of the crystal and the carbon, electroconductivity is improved and the rate characteristic is further improved together with the diffusion coefficient of the lithium ions. Any carbon may be used as long as said carbon has electro conductivity.

For example, the carbon may be carbon black such as Ketjen black, acetylene black, and channel black, fullerene, carbon nanotube, carbon nanofiber, amorphous carbon, carbon fiber, natural graphite, artificial graphite, graphitized Ketjen black, mesoporous carbon, and gas phase method carbon fiber. The carbon nanotube may be either single wall carbon nanotube (SWCNT) or multi wall carbon nanotube (MWCNT).

Furthermore, a compound that can realize capacity at the reaction potential equivalent to or more than the present lithium vanadium oxide crystal may be used for an electrode active material layer together with the present lithium vanadium oxide crystal. For example, the electrode active material layer may include Li₄Ti₅O₁₂, hard carbon, MXene that is secondary nanomaterial formed by a composite atomic layer compound of transition metal and carbon or nitrogen, organic lithium dicarboxylic acid compound, lithium tungstate (Li₄WO₅), and Y₂Ti₂O₅S₂.

(Production Method of Present Lithium Vanadium Oxide Crystal)

The present lithium vanadium oxide crystal is obtained via a mixing process and a heating process of a lithium source, a vanadium source, and a source of tetravalent metal species M. The heating process is preferably divided into a pre-heating process and a sintering process. In the pre-heating process, the lithium vanadium oxide crystal with β-phase crystal structure is synthesized, and in the sintering process, the metal species M is dissolved to phase-transit said crystal into the present lithium vanadium oxide crystal with γ-phase crystal structure. By this, the excellently crystalline present lithium vanadium oxide crystal can be obtained.

The composite of said crystal and carbon can be obtained by mixing the present lithium vanadium oxide crystal and carbon after synthesizing the present lithium vanadium oxide crystal. Note that, before the mixing process of the present lithium vanadium oxide crystal and carbon, a crushing process to crush the present lithium vanadium oxide crystal may be introduced to miniaturize the present lithium vanadium oxide crystal. Also, in the mixing process of the present lithium vanadium oxide crystal and carbon, the present lithium vanadium oxide crystal may be further finely crushed and conjugated with carbon. If the present lithium vanadium oxide crystal and carbon are not to be conjugated, only a production process of the present lithium vanadium oxide crystal may be performed.

Firstly, in the mixing process of the lithium source, the vanadium source, and the source of tetravalent metal species M, each material source is uniformly dispersed to cause uniform solid phase reaction in the sintering process. For example, the mixing method of each material source may be a solid phase method using mixers. In the mixing method using mixers, physical force may be added to the mixture of each material source by bead mills, roller mills, stirring mills, planet mills, vibration mills, homogenizers, and homo mixers. In the mixing process, the mixing ratio of each material source may be in accordance with stoichiometric ratio of the present lithium vanadium oxide crystal. For example, in the case of Li_{3.2}V_{0.8}M_{0.2}O₄, each material source may be mixed in the ratio of Li:V:M=3.2:0.8:0.2 in molecular weight.

The lithium source may be lithium containing compounds such as lithium hydroxide, lithium hydroxide hydrates, lithium acetate, lithium nitrate, lithium carbonate, lithium chloride, lithium lactate. The vanadium source may be metavanadates (such as NH₄VO₃, NaVO₃, KVO₃), vanadium oxide (V₂O₅, V₂O₄, V₂O₃, V₃O₄), vanadyl (III) acetylacetonate, vanadyl (IV) oxyacetylacetonate, vanadium trichloride oxide, vanadium tetrachloride, vanadium trichloride, and polyvanadates, etc. In the case the metal species M is Si, the source of the metal species M may be silicon oxides such as SiO₂ or Li₂SiO₃, powder Si, or amorphous Si. It is preferable that the average value of the particle diameter of SiO₂ is in the range of 10 nm to 20 nm. By using SiO₂ with particle diameter in this range as the metal species M, the present lithium vanadium oxide crystal with only γ-phase can be efficiently obtained.

In the pre-heating process, the mixture of each material source is heated by the temperature lower than the temperature at which the β-phase structure transit to the γ-phase structure. For example, in the pre-heating process, the mixture is heated under air atmosphere at 600 to 800° C. for about five hours. In the sintering process, the mixture of the β-phase lithium vanadium oxide crystal that was synthesized by the pre-heating process and the material source of the tetravalent metal species M is heated. For example, in the sintering process, the mixture is heated under air atmosphere and at 800 to 1000° C. for about eight hours. By this, powder of the present lithium vanadium oxide crystal, which has the crystal structure of only γ-phase and which is dissolved so that the coefficient x of the tetravalent metal species M is equal to or more than 0.2, is synthesized, and this present lithium vanadium oxide crystal maintains the γ-phase crystal structure even if it is cooled naturally.

Next, when conjugating the present lithium vanadium oxide crystal and carbon, firstly, only the present lithium vanadium oxide crystal obtained in the sintering process is stirred in the liquid phase. The present lithium vanadium oxide crystal is crushed and miniaturized in the liquid phase. At this time, it is desirable that carbon is not added. If carbon is not added, nanoparticles of the present lithium vanadium oxide crystal would be easily, uniformly, and efficiently formed for there is no contact between the present lithium vanadium oxide crystal and carbon. Solvent is not particularly limited if the solution does not give an adverse effect to the reaction, and water, methanol, ethanol, and isopropyl alcohol, etc., may be preferably used. Two types or more solvent may be mixed and used.

In the stirring process, mixers, jet mixing (jet collision), and ultrasonic processing may be used. For example, in the stirring process using mixers, the crystal is stirred by rotation speed of 800 rpm, etc., for 10 minutes. By the dispersion scheme by jet mixing, a pair of nozzles is provided at positions facing with each other on an inner wall of a cylindrical chamber, and the mixture solution is pressurized by high pressure pumps and is ejected from the pair of nozzles to collide head-on to the crystal.

After stirring the present lithium vanadium oxide crystal in the liquid phase, the present lithium vanadium oxide crystal is vacuum dried. The solution is removed by the vacuum drying. That is, in the vacuum drying process, the crystal is heated by temperature and time at which the solvent volatilize.

After the present lithium vanadium oxide crystal is vacuum dried and the solvent is removed, carbon is added and mixed to the present lithium vanadium oxide crystal. In the mixing process of the present lithium vanadium oxide crystal and carbon, the present lithium vanadium oxide crystal is attached on a surface of carbon while crushing the present lithium vanadium oxide crystal to make the nanoparticles thereof. In the mixing process, mechanochemical processing, mixers, jet mixing (jet collision), and ultrasonic processing may be used. The mechanochemical processing is a process to apply mechanical energy such as shear stress and centrifugal force using a revolving reaction container. The present lithium vanadium oxide crystal is crushed by mechanical force and is attached on carbon. For example, in the mixing process by mixers, the crystal and carbon may be mixed at 300 rpm, etc., for three hours or more, such as 12 hours or more.

### EXAMPLE

In below, examples of the present disclosure are described, however, the present disclosure is not limited thereto. Firstly, various types of lithium vanadium oxide crystal were synthesized. As for the material source, the lithium source was powder of lithium carbonate (Li₂CO₃) (Product: 3N5 from KANTO CHEMICAL CO., INC., 24121-08), the vanadium source was vanadium pentoxide (V₂O₅) (Product: vanadium oxide (V) from KANTO CHEMICAL CO., INC., 24121-08), and the source of metal species M was powder of silicon dioxide (SiO₂) (Product: silicon dioxide, 99.9% from FUJIFILM Wako Pure Chemical Corporation, 192-09071). The lithium source, the vanadium source, and the source of the metal species M were mixed in accordance with stoichiometric ratio.

In comparative example 1, the metal species M was not doped, and each material source was mixed to synthesize lithium vanadium oxide crystal expressed by the chemical formula Li₃V₁O₄. In comparative example 2, each material source was mixed to synthesize lithium vanadium oxide crystal expressed by the chemical formula Li_{3.05}V_{0.95}Si_{0.05}O₄ in which coefficient x of Si was 0.05. In comparative example 3, each material source was mixed to synthesize lithium vanadium oxide crystal expressed by the chemical formula Li_{3.1}V_{0.9}Si_{0.1}O₄ in which coefficient x of Si was 0.1.

In example 1, each material source was mixed to synthesize the present lithium vanadium oxide crystal expressed by the chemical formula Li_{3.2}V_{0.8}Si_{0.2}O₄ in which coefficient x of Si was 0.2. In example 2, each material source was mixed to synthesize the present lithium vanadium oxide crystal expressed by the chemical formula Li_{3.4}V_{0.6}Si_{0.4}O₄ in which coefficient x of Si was 0.4. In comparative example 4, each material source was mixed to synthesize the present lithium vanadium oxide crystal expressed by the chemical formula Li_{3.6}V_{0.4}Si_{0.6}O₄ in which coefficient x of Si was 0.6.

In detail, the powder of lithium carbonate, the powder of vanadium pentoxide, and the powder of silicon dioxide were mixed by a ball mill (Fritsch, Premium Line (PL-7)). When mixing, the mixer is operated for 2 minutes at 300 rpm and the mixer then was stopped. This was repeated six times. After the mixing, the mixture was pelletized. In the pelletizing, the mixture was input to die of 20φ, was temporary molded by applying pressure of 20 MPa for 1 minute, was input to die of 20φ, and was molded by applying pressure of 30 MPa for 1 minute. After the pelletizing, the mixture was heated under air atmosphere at 600° C. for five hours. After the heating, the mixture was further sintered under air atmosphere at 900° C. for eight hours.

The powder obtained by the sintering was added top ethanol and was mixed by a ball mill (Fritsch, Premium Line (PL-7)) at rotation speed of 800 rpm for two minutes. After the mixing, the powder was vacuum dried at 80° C. for one night. Next, the dried powder and carbon was conjugated. Multi wall carbon nanotube (MWCNT) was used as the carbon to be conjugated with the lithium vanadium oxide crystal. The average fiber diameter of the MWCNT was 11 nm, and the mixing ratio of the lithium vanadium oxide crystal and the MWCNT was 80:20 in weight. In detail, the MWCNT was added to the dried powder and was mixed by a ball mill at rotation speed of 300 rpm for 12 hours.

(Identification of Crystal Structure)

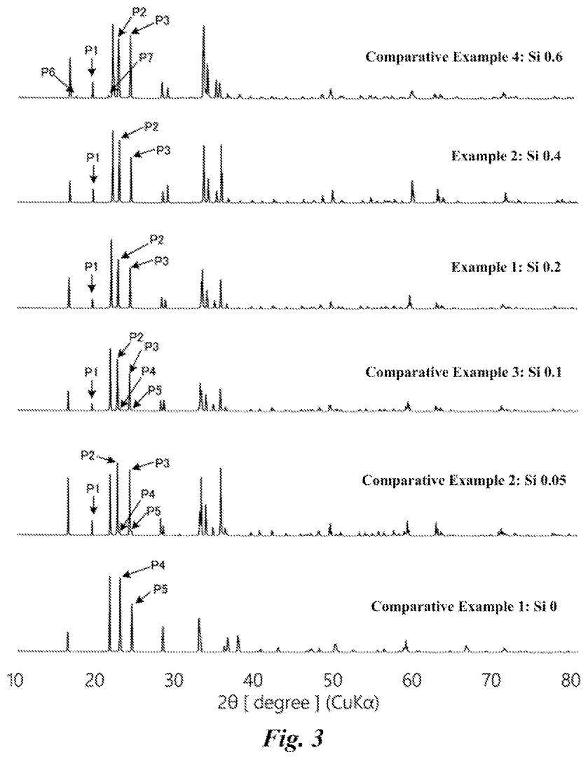

The composite of each example and comparative example were analyzed by powder X-ray diffraction under normal temperature environment. The result is shown in FIG. 3. When making the graph, broad halo patterns resulting from carbon were removed. In the graph of FIG. 3, from bottom to top, the comparative example 1 to which the metal species M was not doped, the comparative example 2 expressed by the chemical formula Li_{3.05}V_{0.95}Si_{0.05}O₄ in which coefficient x of Si was 0.05, the comparative example 3 expressed by the chemical formula Li_{3.1}V_{0.9}Si_{0.1}O₄ in which coefficient x of Si was 0.1, the example 1 expressed by the chemical formula Li_{3.2}V_{0.8}Si_{0.2}O₄ in which coefficient x of Si was 0.2, the example 2 expressed by the chemical formula Li_{3.4}V_{0.6}Si_{0.4}O₄ in which coefficient x of Si was 0.4, and the comparative example 4 expressed by the chemical formula Li_{3.6}V_{0.4}Si_{0.6}O₄ in which coefficient x of Si was 0.6 are shown.

As illustrated in FIG. 3, in the graph of the comparative example 1, there is no peak P1 near the incident angle 2θ of 19°. Therefore, the lithium vanadium oxide crystal included in the comparative example 1 only has the β-phase crystal structure.

In the graphs of the comparative examples 2 and 3, there is the peak P1 near the incident angle 2θ of 19°. Therefore, it can be observed that the lithium vanadium oxide crystal included in the comparative examples 2 and 3 has the β-phase crystal structure under normal temperature environment. However, in the graphs of the comparative examples 2 and 3, the small peaks P4 and P5 remains in the range of the incident angle 2θ of 22.7° to 22.9° and 24.1° to 24.3° right next at the higher angle side of the peaks P2 and P3 with high intensity. Therefore, it is considered that the lithium vanadium oxide crystals included in the comparative examples 2 and 3 have both the β-phase and the γ-phase.

In the graphs of examples 1 and 2, there is the peak P1 near the incident angle 2θ of 19°, there are the peaks P2 and P3 with high intensity, and the peaks 4 and 5 has disappeared from the range of the incident angle 2θ of 22.7° to 22.9° and 24.1° to 24.3° right next at the higher angle side of said peaks P2 and P3. Therefore, the lithium vanadium oxide crystals included in the examples 1 and 2 have the single crystal structure of only γ-phase.

In the graph of the comparative example 4, there is the peak P1 near the incident angle 2θ of 19°, there are the peaks P2 and P3 with high intensity, and the peaks 4 and 5 has disappeared from the range of the incident angle 2θ of 22.7° to 22.9° and 24.1° to 24.3° right next at the higher angle side of said peaks P2 and P3. Therefore, the lithium vanadium oxide crystal included in the comparative examples 4 has the single crystal structure of only γ-phase. However, since there is the peaks P6 and P7 at the incident angle 2θ of 17.3° and 21.4°, impurities are included.

Furthermore, the crystallite size of the present lithium vanadium oxide crystal includes in the composite of the example 1 was measured based on the diffraction pattern obtained by the powder X-ray diffraction. The crystallite size was obtained by using Scherrer's formula, Scherrer constant K, X-ray wavelength λ, half value β, and Bragg angle θ. The Scherrer constant was K=0.9.

As a result, the average crystallite size of the present lithium vanadium oxide crystal of the example 1 before the mixing process with carbon, that is, before the stirring process of the present lithium vanadium oxide crystal, the vacuum drying process, and the mixing process with carbon was 113±1 nm in the axis-a direction, 127±2 nm in the axis-b direction, and 123±1 nm in the axis-c direction. In contrast, the average crystallite size of the present lithium vanadium oxide crystal of the example 1 after conjugated with carbon was 47±8 nm in the axis-a direction, 40±3 nm in the axis-b direction, and 38±1 nm in the axis-c direction. That is, it can be observed that the present lithium vanadium oxide crystal of the example 1 was miniaturized for 100 nm or less.

(Evaluation of Lithium-Ion Diffusion Coefficient)

Half cells were produced using the composite of the lithium vanadium oxide crystal and carbon of the comparative examples 1 to 3 and the examples 1 and 2. The half cell was 2032-type coil cell. In detail, polyvinylidene fluoride (PVDF) was selected as a binder, and the composite and the binder were stirred together and were made slurry, and were applied on a copper foil to produce a working electrode W.E. The ratio of the composite and the binder was 90:10 in weight.

A counter electrode was lithium metal and was adhered at the lower lid of the 2032-type coil cell. A glass separator, a gasket, the working electrode W.E., a spacer, a spring, and an upper lid were layered on the counter electrode C.E. in this order, and they were fastened to produce the cell. For electrolyte solution, ethylene carbonate (EC) and dimethyl carbonate (DEC) as the solvent, and 1.0M lithium hexafluorophosphate as the solute were mixed and adjusted. The ratio thereof was EC:DEC=1:1 in volume. The cell was impregnated with said electrolyte solution.

Then, the lithium-ion diffusion coefficient for the half cells of each comparative example and example was evaluated. The lithium-ion diffusion coefficient was measured by GITT (Galvanostatic Intermittent Titration Technique), and the lithium-ion diffusion coefficient D was calculated according to the following formula 1.

$${D}_{{Li}^{+}} = \frac{4}{π t} {( \frac{{m}_{B} {V}_{M}}{{M}_{B} A} )}^{2} {( \frac{Δ {E}_{s}}{Δ {E}_{τ}} )}^{2} \qquad ( Formula 1 )$$

In the formula, m_{B} is electrode weight (g), V_{M} is molar volume (cm³mol⁻¹), M_{B} is molar weight (gmol⁻¹), and A is electrode area (cm²). Furthermore, the current value was 100 mAg⁻¹ (g is per composite), the discharging time was 1800 seconds, and the downtime was 3600 seconds.

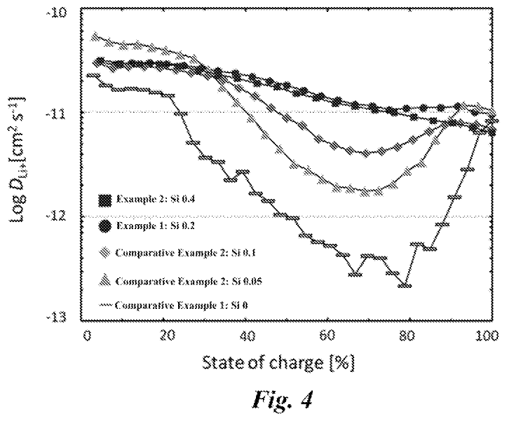

The result of the lithium-ion diffusion coefficient is shown in FIG. 4. As illustrated in FIG. 4, for each capacity (mAhg⁻¹), the lithium-ion diffusion coefficient of the composite of the present lithium vanadium oxide crystal and carbon of the examples 1 and 2 were higher than the lithium-ion diffusion coefficient of the composite of the lithium vanadium oxide crystal and carbon of the comparative examples 1 to 3, and were gentle as there were no portion that had keenly decrease. Furthermore, according to FIG. 4, the lithium-ion diffusion coefficient of the composite of the present lithium vanadium oxide crystal and carbon of the examples 1 and 2 were improved by 2 digits or more in comparison with the lithium-ion diffusion coefficient of the composite of the lithium vanadium oxide crystal and carbon of the comparative examples 1 to 3.

That is, it was observed that the lithium-ion diffusion coefficient of the present lithium vanadium oxide crystal had been improved by having the single crystal structure of only γ-phase and being dissolved so that the coefficient x of the silicon atom was equal to or more than 0.2.

(Discharging Test)

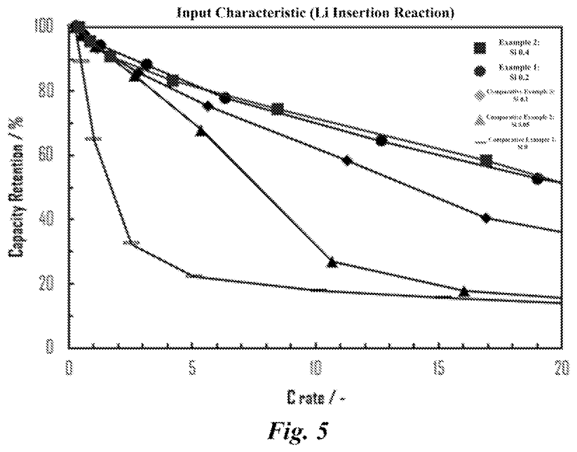

Next, the rate characteristic of the half cells using the composite of the comparative examples 1 to 3 and the examples 1 and 2 were evaluated. The potential range (vs. Li/Li⁺) of the working electrode W.E. relative to the half cell was 2.5 V-0.76 V. Then, the desorption of the lithium ions was fixed to 0.1 Ag⁻¹ (g was per composite), the insertion of the lithium ions was changed to 0.02-12 Ag⁻¹, and the capacity retention rate at the time of charging at each C rate was measured. The result is shown in FIG. 5. FIG. 5 is a graph illustrating relationship between the charging capacity retention rate and the C rate in which the horizontal axis is the C rate, and the vertical axis is the charging ratio relative to the theoretical capacity.

As illustrated in FIG. 5, the input characteristic of the composite of the comparative example 1 keenly decreased as the C rate increases. The comparative example 1 is the composite of lithium vanadium oxide crystal with the single crystal structure of only β-phase, and carbon. The input characteristic of the composite of the comparative examples 2 and 3 also keenly decreased as the C rate increases though the decrease was gentler than the comparative example 1. The comparative examples 2 and 3 were the composite of the lithium vanadium oxide crystal with the β-phase and the γ-phase single crystal structure to which Si atoms were doped so that the coefficient x would be less than 0.2, and carbon.

In contrast, the decrease in the input characteristic of the examples 1 and 2 was very gentle even when the C rate was increased, and there was no keen decrease in the input characteristic. Therefore, for example, when the C rate was 20, the composite of the examples 1 and 2 maintained higher capacity retention rate compared to the comparative examples 1 to 3. The examples 1 and 2 were the composite of the present lithium vanadium oxide crystal with the single crystal structure of only γ-phase to which Si atoms were doped so that the coefficient x would be equal to or more than 0.2, and carbon.

That is, since the lithium-ion diffusion coefficient is improved, when the present lithium vanadium oxide crystal was used in the power storage device, the input/output of said power storage device is improved. Furthermore, by conjugating the crystal with carbon, high electric conductivity can be obtained synergistically together with the improvement of the lithium-ion diffusion coefficient, and the rate characteristic is significantly improved.

1. A lithium vanadium oxide crystal which is Li₃VO₄ to which tetravalent metal species M is doped, wherein:
the lithium vanadium oxide crystal is represented by a chemical formula of Li₃₊₁V₁₋ₓMₓO₄ and includes a single crystal structure of only γ-phase as Li₃VO₄ under a temperature environment including normal temperature, and
a tetravalent metal species M is included in a ratio of x≥0.2.

2. The lithium vanadium oxide crystal according to claim 1, wherein the tetravalent metal species M is Si.

3. The lithium vanadium oxide crystal according to claim 2, wherein the tetravalent metal species M is included in a ratio of 0.2≤x≤0.4.

4. Electrode material including the lithium vanadium oxide crystal according to claim 3.

5. The electrode material according to claim 4, having composite particles formed by conjugating the lithium vanadium oxide crystal and carbon.

6. A power storage device employing the electrode material according to claim 5 in a negative electrode or a positive electrode.

7. A production method of a lithium vanadium oxide crystal which is represented by a chemical formula of Li₃₊₁V₁₋ₓMₓO₄ and is Li₃VO₄ to which tetravalent metal species M is doped, comprising:
a mixing process of mixing a lithium source, a vanadium source, and a source of tetravalent metal species M added in a ratio of x≥0.2, and
a heating process of heating a mixture obtained in the mixing process under temperature environment equal to or more than temperature at which a phase of the mixture structurally transits to a γ-phase.

8. The production method of the lithium vanadium oxide crystal according to claim 7, comprising a pre-heating process of heating the mixture obtained in the mixing process under temperature environment less than the temperature at which the phase of the mixture structurally transits to the γ-phase between the mixing process and the heating process,
wherein the heating process heats the mixture after the mixing process and after the pre-heating process.

9. The lithium vanadium oxide crystal according to claim 1, wherein the tetravalent metal species M is included in a ratio of 0.2≤x≤0.4.

10. Electrode material including the lithium vanadium oxide crystal according to claim 9.

11. The electrode material according to claim 10, having composite particles formed by conjugating the lithium vanadium oxide crystal and carbon.

12. A power storage device employing the electrode material according to claim 11 in a negative electrode or a positive electrode.

13. Electrode material including the lithium vanadium oxide crystal according to claim 1.

14. The electrode material according to claim 13, having composite particles formed by conjugating the lithium vanadium oxide crystal and carbon.

15. A power storage device employing the electrode material according to claim 14 in a negative electrode or a positive electrode.

16. Electrode material including the lithium vanadium oxide crystal according to claim 2.

17. The electrode material according to claim 16, having composite particles formed by conjugating the lithium vanadium oxide crystal and carbon.

18. A power storage device employing the electrode material according to claim 17 in a negative electrode or a positive electrode.
